(19) United States
(12) Patent Application Publication
(10) Pub. No.: US 2008/0151571 A1
(43) Pub. Date: Jun. 26, 2008

(54) Ornamental electronic candle

(76) Inventor: Kuo-Fang Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/656,419

(22) Filed: Jan. 23, 2007

(30) Foreign Application Priority Data
Dec. 21, 2006 (TW) 095222535

(51) Int. Cl. F21S 10/04

(52) U.S. Cl. 362/569

(57) ABSTRACT

An ornamental electronic candle including: an ornamental candle main body having a top face, a bottom face and an opening formed on the candle main body; an ornamental flame body erected on the top face of the candle main body, whereby light beam can go through the flame body; light emitters hidden in the flame body to emit light outward through the flame body; and a lighting control circuit arranged in the candle main body for controllably extinguishing or lighting up the light emitters. The lighting control circuit includes a microphone arranged at the opening of the candle main body, whereby an airflow going through the opening is able to control the operation of the microphone so as to controllably extinguish or light up the light emitters.

### BACKGROUND OF THE INVENTION

1. Field of the Invention

The present invention is related to an ornamental candle, and more particularly to an ornamental electronic candle which can be extinguished or lighted up by means of blowing with mouth.

2. Descriprion of the Prior Art

A conventional candle can burn in flames. In use of the conventional candle, a user must be very careful. In case of incaution, a fire may take place to cause loss of human lives and properties.

In order to avoid such problem, many kinds of ornamental electronic candles have been developed. For example, U.S. Pat. No. 6,616,308 discloses an imitation candle having a transparent main body 18. A light source 24 is hidden in the main body 18. When the light source 24 is lighted up, the light beam can go through the main body 18 to outer side. Such imitation candle has no flame and is quite different from the real candle with flame.

Also, the flame of a real candle is extinguishable by blowing. However, the imitation candle can be only switched off. Therefore, the imitation candle still can hardly lively imitate the real candle.

Some existent electronic candles have ornamental flames erected on the top faces of the main bodies. The light emitters are hidden in the ornamental flames to emit light outward through the ornamental flames to simulate real flames. However, such electronic candles are still turned on/off by switching. This can hardly achieve a live effect.

### SUMMARY OF THE INVENTION

It is therefore a primary object of the present invention to provide an ornamental electronic candle which has a live simulative flame body as a real flame. In addition, a user can blow the flame body of the electronic candle with the mouth to extinguish the light emitters hidden in the flame body. Therefore, the electronic candle can be used just as a real candle.

According to the above object, the ornamental electronic candle of the present invention includes:

an ornamental candle main body having a top face, a bottom face and an opening formed on the candle main body;

an ornamental flame body erected on the top face of the candle main body, whereby light beam can go through the flame body;

light emitters hidden in the flame body to emit light outward through the flame body; and

a lighting control circuit arranged in the candle main body for controllably extinguishing or lighting up the light emitters, the lighting control circuit including a microphone arranged at the opening of the candle main body, whereby an airflow going through the opening is able to control the operation of the microphone so as to controllably extinguish or light up the light emitters.

In the above ornamental electronic candle, the opening is formed on the top face of the candle main body.

Still according to the above object, the ornamental electronic candle of the present invention includes:

an ornamental candle main body having a top face, a bottom face and an opening formed on the candle main body, the top face of the candle main body being formed with a cylindrical depression, the cylindrical depression having a recessed face lower than the top face;

an ornamental flame body erected on the recessed face of the cylindrical depression of the candle main body, whereby light beam can go through the flame body;

light emitters hidden in the flame body to emit light outward through the flame body; and

a lighting control circuit arranged in the candle main body for controllably extinguishing or lighting up the light emitters, the lighting control circuit including a microphone arranged at the opening of the candle main body, whereby an airflow going through the opening is able to control the operation of the microphone so as to controllably extinguish or light up the light emitters.

In the above ornamental electronic candle, the opening is formed on the recessed face of the cylindrical depression of the candle main body.

Still according to the above object, the ornamental electronic candle of the present invention includes:

an ornamental candle main body having a top face, a bottom face and an opening formed on the candle main body, the top face of the candle main body being formed with a truncated conic depression, the truncated conic depression having a recessed face lower than the top face;

an ornamental flame body erected on the recessed face of the truncated conic depression of the candle main body, whereby light beam can go through the flame body;

light emitters hidden in the flame body to emit light outward through the flame body; and

a lighting control circuit arranged in the candle main body for controllably extinguishing or lighting up the light emitters, the lighting control circuit including a microphone arranged at the opening of the candle main body, whereby an airflow going through the opening is able to control the operation of the microphone so as to controllably extinguish or light up the light emitters.

In the above ornamental electronic candle, the opening is formed on the recessed face of the truncated conic depression of the candle main body.

The present invention can be best understood through the following description and accompanying drawings wherein:

### BRIEF DESCRIPTION OF THE DRAWINGS

FIG. 1 is a perspective view of a first embodiment of the present invention;

FIG. 2 is a sectional view taken along line 2-2 of FIG. 1;

FIG. 3 is a perspective view of a second embodiment of the present invention;

FIG. 4 is a sectional view taken along line 4-4 of FIG. 3;

FIG. 5 is a perspective view of a third embodiment of the present invention;

FIG. 6 is a sectional view taken along line 6-6 of FIG. 5; and

FIG. 7 is a circuit diagram of the lighting control circuit of the present invention.

### DETAILED DESCRIPTION OF THE PREFERRED EMBODIMENTS

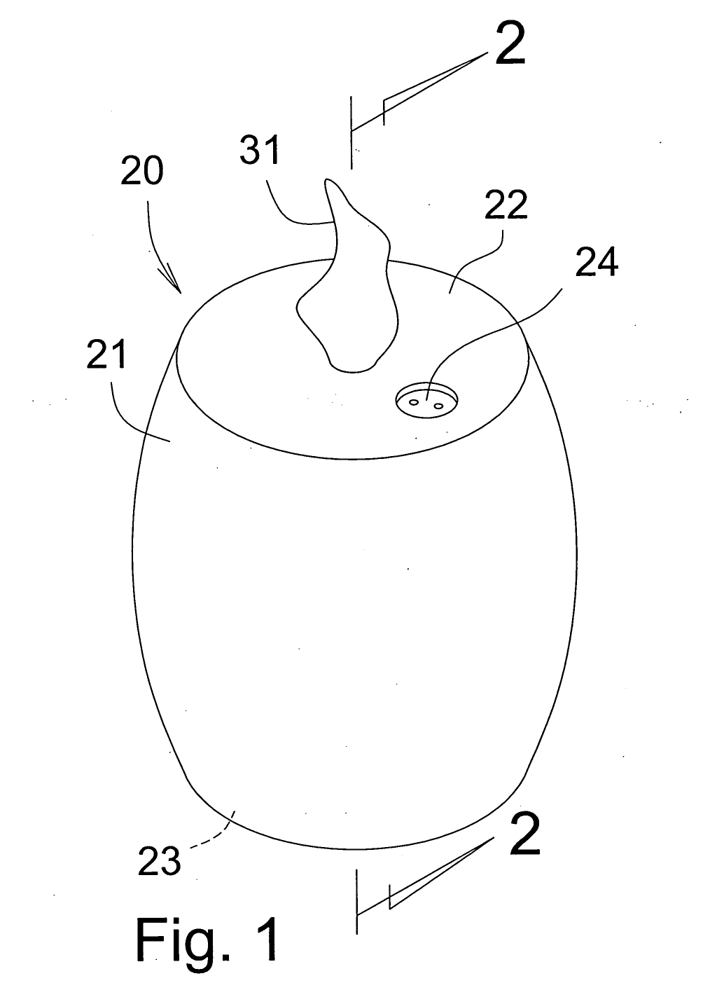

Please refer to FIGS. 1 to 7. The ornamental electronic candle 20 of the present invention includes an ornamental candle main body 21, an ornamental flame body 31, light emitters D1, D2 (light-emitting diodes in this embodiment) and a lighting control circuit 51. The candle main body 21 has a top face 22, a bottom face 23 and an opening 24 formed on the top face 22 of the candle main body 21. The ornamental flame body 31 is erected on the top face 22 of the candle main body 21. The light emitters D1, D2 are hidden in the flame body 31 to emit light outward through the flame body 31. The lighting control circuit 51 is arranged in the candle main body 21 for controllably turning on/off the light emitters D1, D2. The lighting control circuit 51 includes a microphone MK arranged at the opening 24 of the candle main body 21. An airflow going through the opening 24 serves to control the operation of the microphone MK so as to controllably extinguish or light up the light emitters D1, D2.

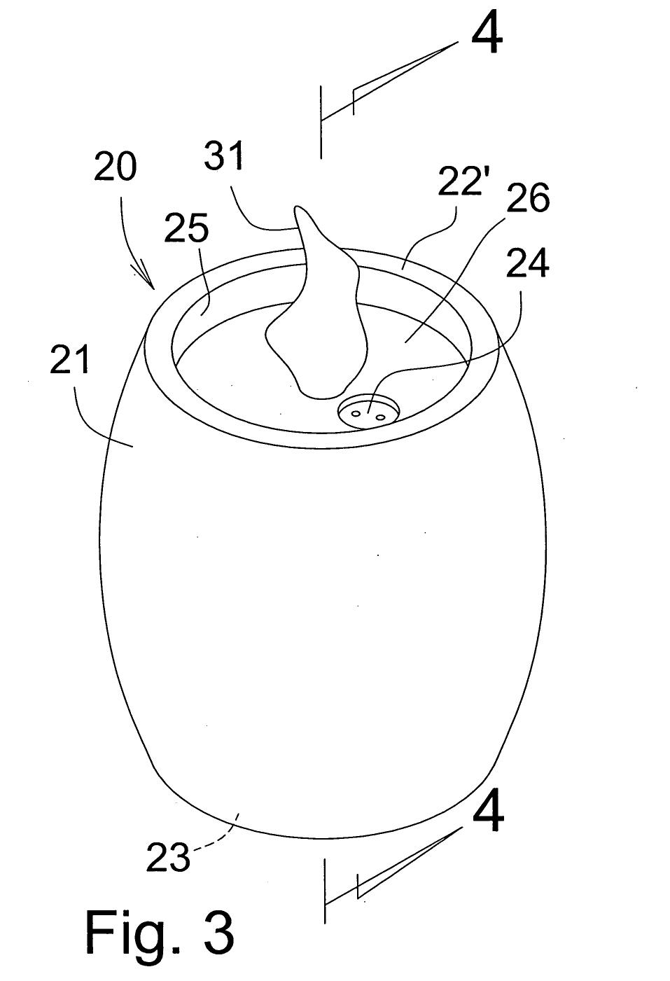

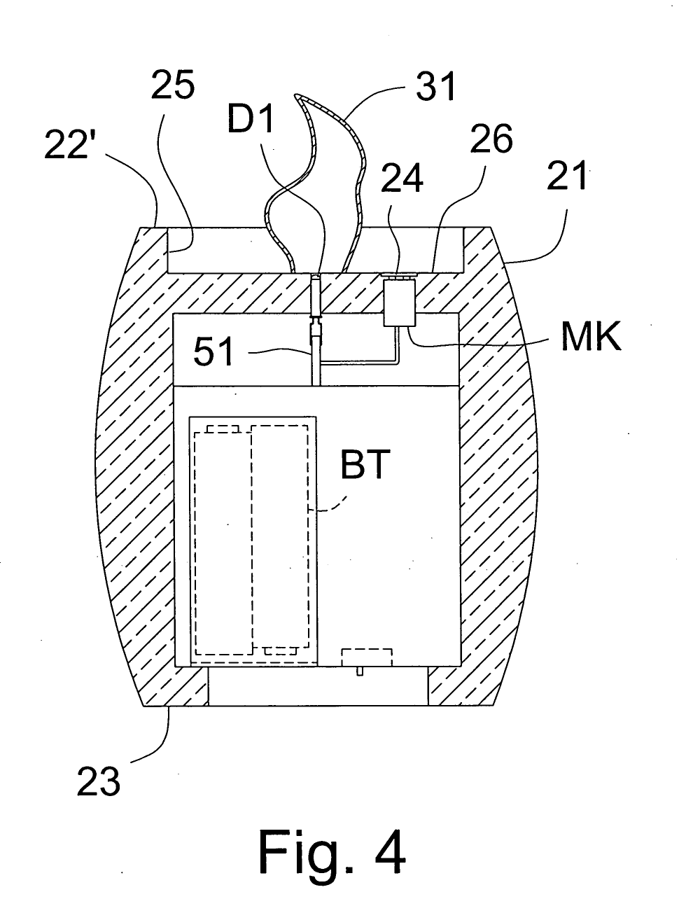

Please refer to FIGS. 3 and 4. Alternatively, the top face 22′ of the candle main body 21 of the electronic candle 20 can be formed with a cylindrical depression 25. The cylindrical depression 25 has a recessed face 26 lower than the top face 22′. The opening 24 is formed on the recessed face 26 of the cylindrical depression 25. The ornamental flame body 31 is erected on the recessed face 26 of the cylindrical depression 25 of the candle main body 21. The light can go through the flame body 31.

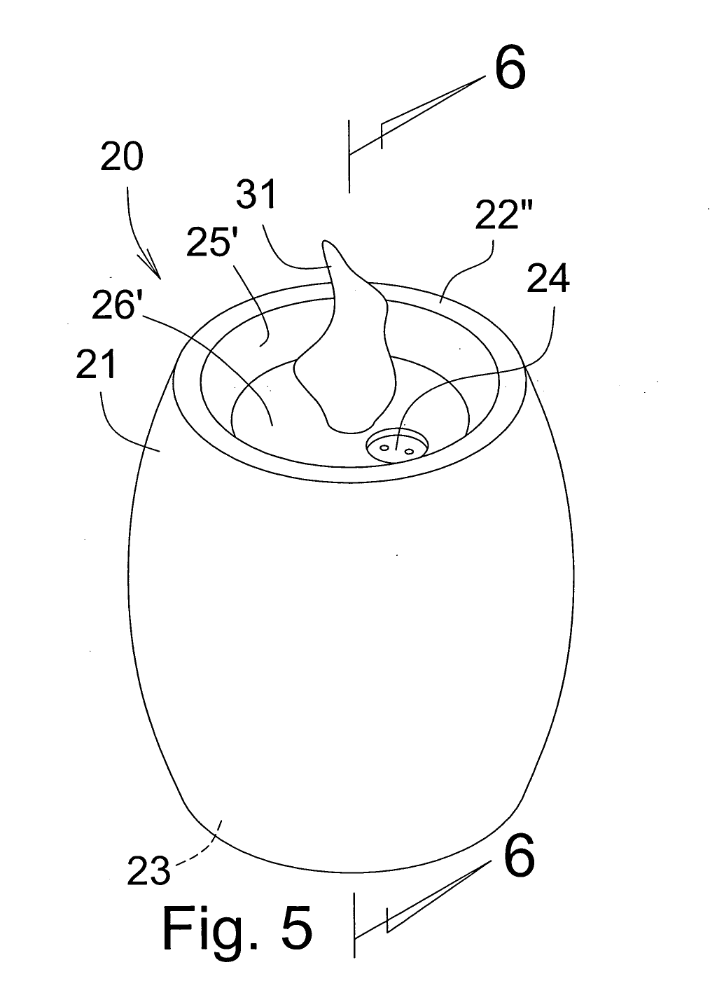

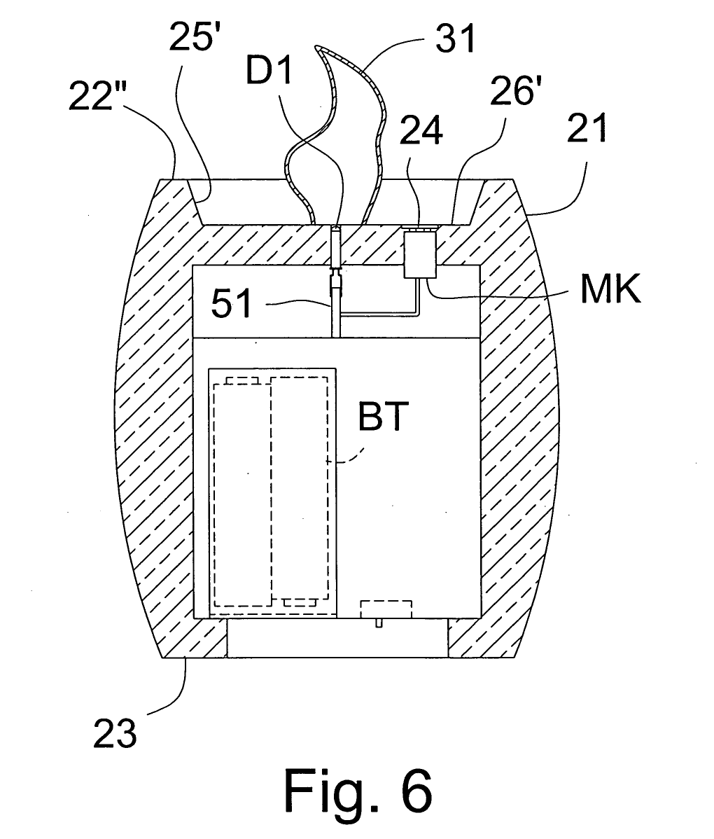

Please refer to FIGS. 5 and 6. Alternatively, the top face 22″ of the candle main body 21 of the electronic candle 20 can be formed with a truncated conic depression 25′. The truncated conic depression 25′ has a recessed face 26′ lower than the top face 22″. The opening 24 is formed on the recessed face 26′ of the truncated conic depression 25′. The ornamental flame body 31 is erected on the recessed face 26′ of the truncated conic depression 25′ of the candle main body 21. The light can go through the flame body 31.

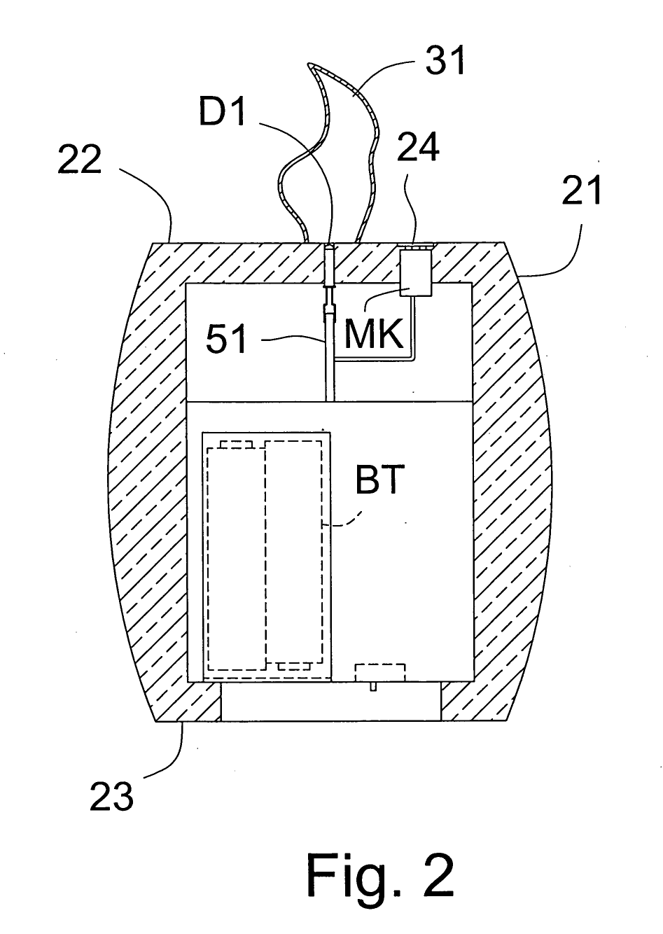

Please refer to FIGS. 2, 4, 6 and 7. The lighting control circuit 51 is powered by the power supply BT as shown in FIGS. 2 and 4. The lighting control circuit 51 includes a microphone MK and a logic unit 52. The power supply BT can be a battery or the civil power to supply necessary power for the lighting control circuit 51. When the microphone MK generates a current due to airflow vibration, the microphone MK drives the base of the transistor Q1 to activate the logic unit 52 through the pin P5 thereof. The logic unit 52 sends out current to energize the light emitters D1, D2 respectively through the pins P7 and P8. Accordingly, the light emitters D1, D2 are alternately turned on/off to achieve a live flickering effect as a flame.

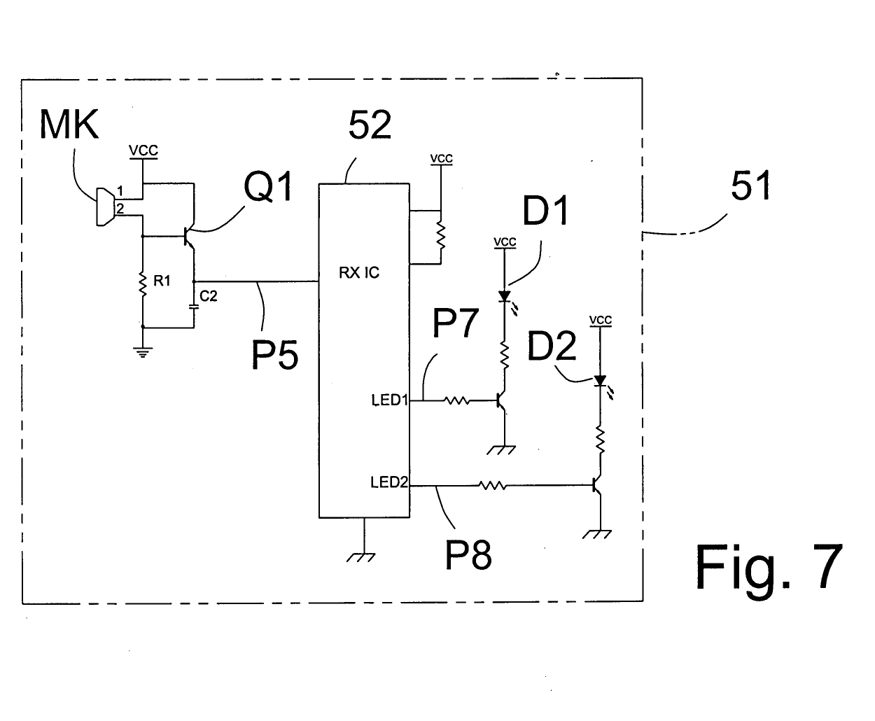

Referring to FIG. 7, the lighting control circuit 51 is powered by the power supply BT as shown in FIGS. 2, 4 and 6 or is directly powered by the civil power (not shown). The lighting control circuit 51 includes a microphone MK and a logic unit 52. The power supply BT serves to supply necessary power for the lighting control circuit 51. When the microphone MK generates a current due to airflow vibration, the microphone MK drives the base of the transistor Q1 to activate the logic unit 52 through the pin P5 thereof. The logic unit 52 sends out current to energize the light emitters D1, D2 respectively through the pins P7 and P8. Accordingly, the light emitters D1, D2 are alternately turned on/off to achieve a live flickering effect as a flame.

According to the above arrangement, a user can blow the flame body 31 of the electronic candle 20 to extinguish the light emitters D1, D2 or blow again to light up the light emitters D1, D2. This more lively simulates the use of the real candle.

The above embodiments are only used to illustrate the present invention, not intended to limit the scope thereof. Many modifications of the above embodiments can be made without departing from the spirit of the present invention.

What is claimed is:

1. An ornamental electronic candle comprising:
(a) an ornamental candle main body having a top face, a bottom face and an opening formed on the candle main body;
(b) an ornamental flame body erected on the top face of the candle main body, whereby light beam can go through the flame body;
(c) light emitters hidden in the flame body to emit light outward through the flame body; and
(d) a lighting control circuit arranged in the candle main body for controllably extinguishing or lighting up the light emitters, the lighting control circuit including a microphone arranged at the opening of the candle main body, whereby an airflow going through the opening is able to control the operation of the microphone so as to controllably extinguish or light up the light emitters.

2. The ornamental electronic candle as claimed in claim 1, wherein the opening is formed on the top face of the candle main body.

3. An ornamental electronic candle comprising:
(a) an ornamental candle main body having a top face, a bottom face and an opening formed on the candle main body, the top face of the candle main body being formed with a cylindrical depression, the cylindrical depression having a recessed face lower than the top face;
(b) an ornamental flame body erected on the recessed face of the cylindrical depression of the candle main body, whereby light beam can go through the flame body;
(c) light emitters hidden in the flame body to emit light outward through the flame body; and
(d) a lighting control circuit arranged in the candle main body for controllably extinguishing or lighting up the light emitters, the lighting control circuit including a microphone arranged at the opening of the candle main body, whereby an airflow going through the opening is able to control the operation of the microphone so as to controllably extinguish or light up the light emitters.

4. The ornamental electronic candle as claimed in claim 3, wherein the opening is formed on the recessed face of the cylindrical depression of the candle main body.

5. An ornamental electronic candle comprising:
(a) an ornamental candle main body having a top face, a bottom face and an opening formed on the candle main body, the top face of the candle main body being formed with a truncated conic depression, the truncated conic depression having a recessed face lower than the top face;
(b) an ornamental flame body erected on the recessed face of the truncated conic depression of the candle main body, whereby light beam can go through the flame body;
(c) light emitters hidden in the flame body to emit light outward through the flame body; and
(d) a lighting control circuit arranged in the candle main body for controllably extinguishing or lighting up the light emitters, the lighting control circuit including a microphone arranged at the opening of the candle main body, whereby an airflow going through the opening is able to control the operation of the microphone so as to controllably extinguish or light up the light emitters.

6. The ornamental electronic candle as claimed in claim 5, wherein the opening is formed on the recessed face of the truncated conic depression of the candle main body.
